(19) United States
(12) Patent Application Publication
(10) Pub. No.: US 2015/0121763 A1
(43) Pub. Date: May 7, 2015

(54) INVIOLABLE OPENING FRAMES SYSTEM

(71) Applicant: Grigorios ZAFEIROPOULOS, (US)

(72) Inventor: Grigorios Zafeiropoulos, Ano Liossia Attikis (GR)

(21) Appl. No.: 14/401,294

(22) PCT Filed: Apr. 18, 2013
(86) PCT No.: PCT/GR2013/000021

§ 371 Date: Nov. 14, 2014

(30) Foreign Application Priority Data
May 14, 2012 (GR) 20120100259

(51) Int. Cl. E06B 5/11; E06B 1/52; E05C 19/00; E06B 1/36

(52) U.S. Cl. CPC E06B 5/113; E06B 1/36; E06B 1/52; E05C 19/00
USPC 49/394

(57) ABSTRACT

By the invention it is possible for a hinged opening frames system (glazing and shutter), to be constructed, having a sash profile (1) with a groove (2) as shown in FIGS. 4 & 5 and a basic frame's profile (3) with a groove (4), where eventually the locking profile (5), which is initially placed into the groove (2) of the sash profile (1), being pushed out, enters the groove (4) of the basic frame's profile (3), so that the sash's (1) movable framework secures and literally embodies with the basic frame's (3) stable framework, in a way that makes the whole frame completely inviolable. The main motion's transmission accessory (9) is adjusted to the frame's cremone, which by being rotated, transmits motion to the drive belt (12), as shown in FIG. 7, which moves the accessories (7), which push out the locking profiles (5), which in turn enter circumferentially into the groove (4) of the framework assembled by the basic frame's profile (3).

The invention refers to an inviolable system of opening hinged frames, for doors and windows, (glazing and shutters), whose two main profiles (the basic frame & the sash) are designed in such a way, that by the addition of the minimum accessories, enables the entrapment and full integration of the movable framework of the sash into the already stable on the wall, framework of the basic frame.

So far the manufacturing technologies of aluminium systems for hinged opening doors and windows, has not yielded any similar invention. In current systems, the methods of locking the movable framework made of the sash's profile, into the stable framework made of the basic frame's profile, require several and highly time-consuming processes which use many complex and expensive accessories, without eventually achieving an inviolable locking between the two frames. Even in mounting circumferential locking system of multiple points, the chance of an invasion remains feasible, even by using relatively simple forms of mechanical stress upon the locking mechanism of the frame.

Known from the state of the art are DE 3037805 A1, which presents a locking system of opening hinged frames, for doors and windows, but also DE 10321127 A1, which refers to system for closing and latching window vanes, doors and hoods, using the longitudinal movement of rope over inclined plane. Especially DE 3037805 A1 presents a system consisting a hollow plastic profile on the circumferential plane. Aim of the said system is to ultimately provide a seal gasket and not a complete inviolable system of opening hinged frames, resulting to not allowing its use by the skilled, on the state of the art, person for the construction of such system.

The invention, with the intention to solve the above disadvantages, follows a brand new and innovative method in designing and constructing the two profiles, of the sash and of the basic frame, in the hinged opening systems, for doors and windows, achieving a circumferential projection and extension of the sash, which by rotating the cremone to the locking position, penetrates circumferentially into the profile of the basic frame, all the way along the entire length of the perimeter of the framework and makes it totally inviolable.

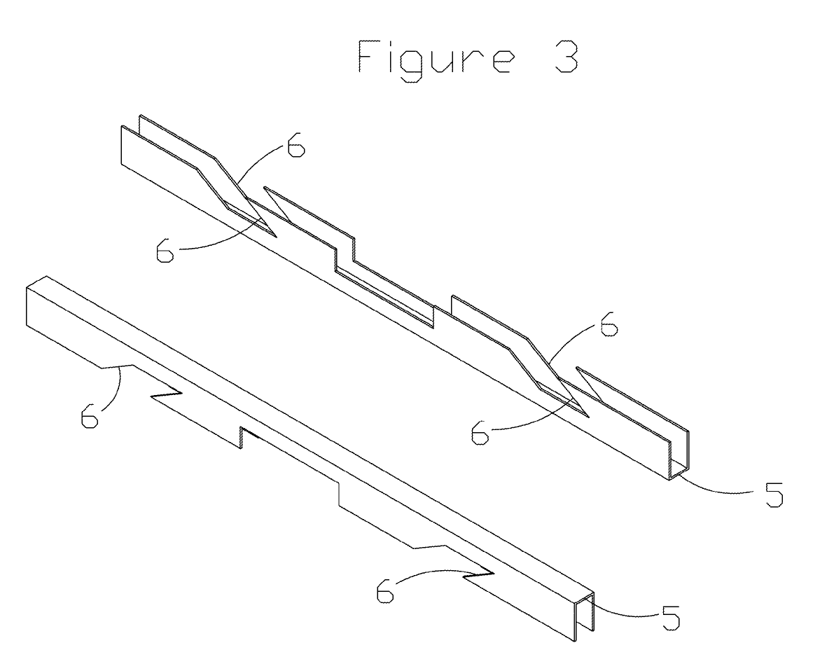

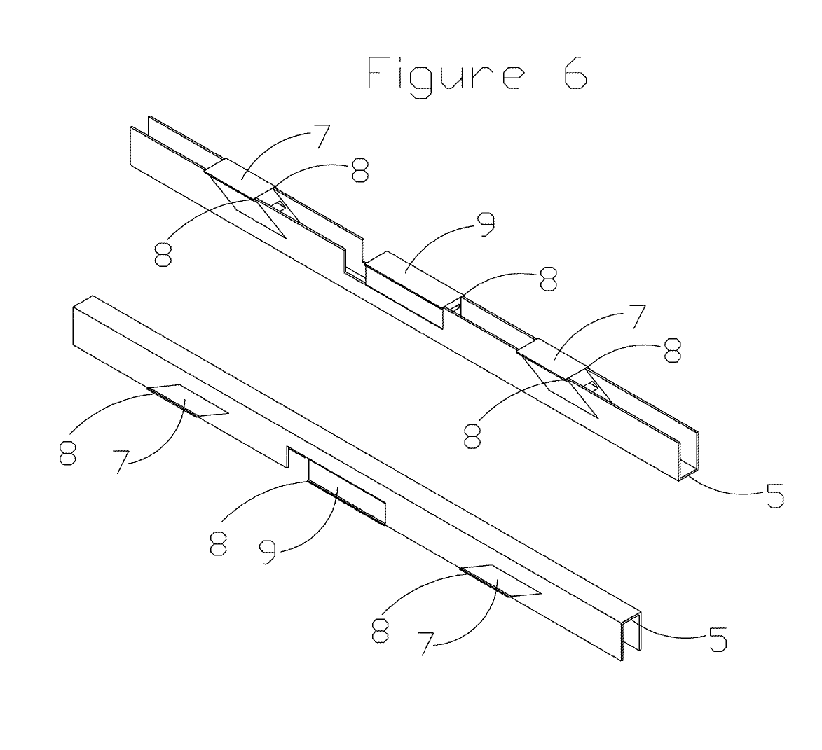

An example of the construction method of the system, is described hereunder, with reference to several drawings which clearly illustrate how to implement the basic principle of the invention, where FIGS. 3 and 6 illustrate accessories of the system in the normal and inverted side, in such a way as to disclose the necessary details:

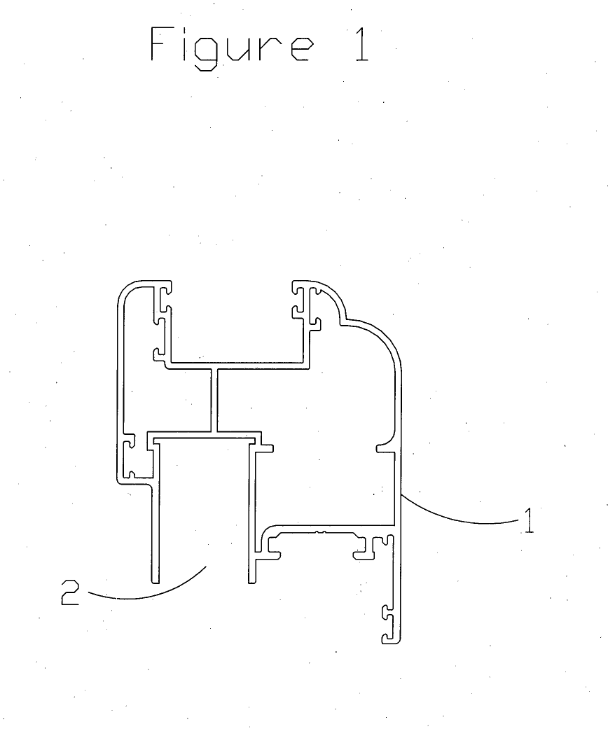

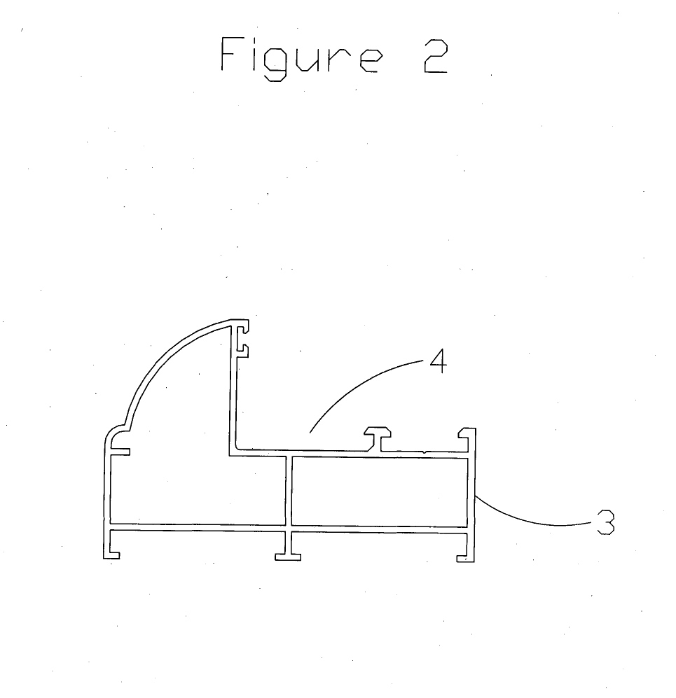

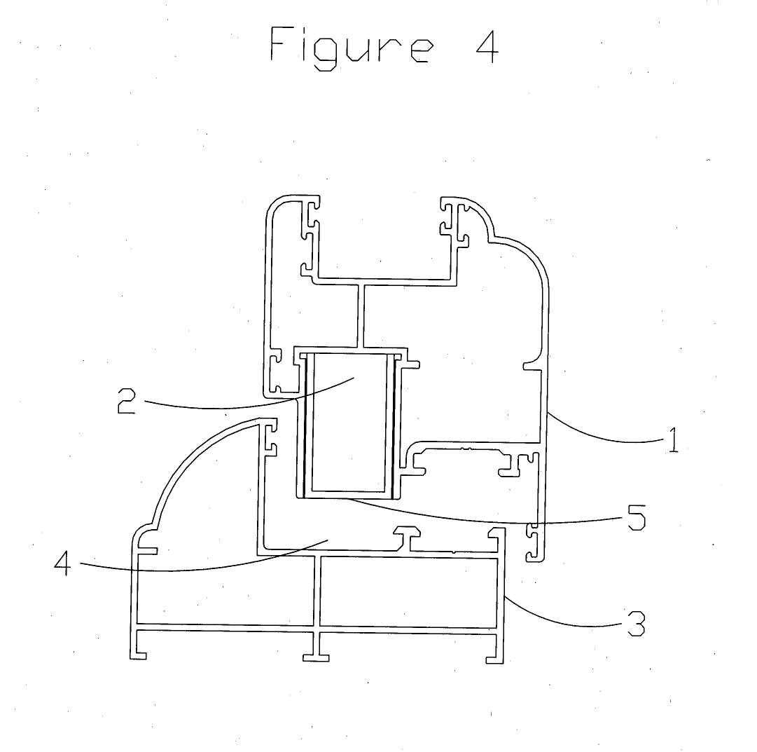

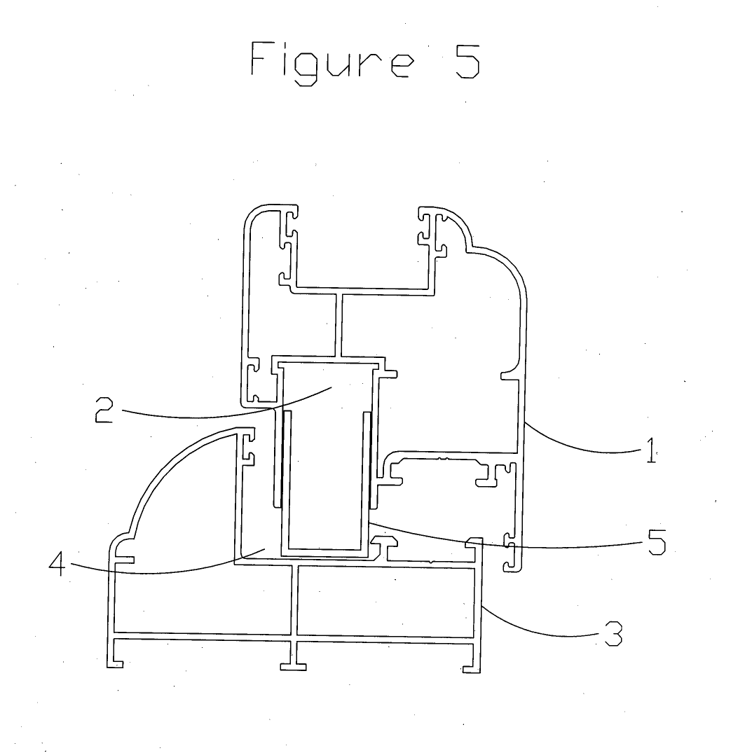

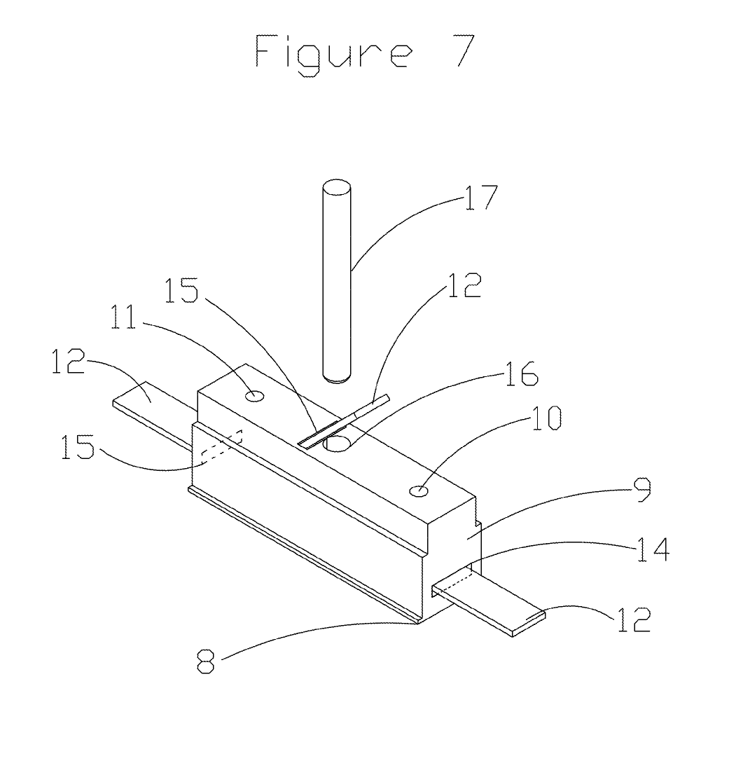

FIG. 1 shows the cross section of a profile of a hinged opening aluminium sash (1), which has been designed, having as its main characteristic the existence of a groove (2). FIG. 2 shows the cross section of a profile of an aluminium basic frame (3), which has as its main characteristic the existence of a groove (4), which is going to host the accessory (5) that is shown in FIG. 3. FIG. 3 shows a part of the locking profile (5), which is in the form of a “π”, which is shaped in such a way that it presents the appropriate inclined material removal at the two facing (opposite) sides, at standard distances. FIG. 4 shows the locking profile's (5) cross section, being placed into the groove (2) of the hinged opening aluminium sash profile (1), in its final place relatively to the profile of the basic frame (3). In FIG. 4, the locking system has not been activated. FIG. 5 shows the same cross section as in FIG. 4, with the difference that the locking system is activated and the locking profile (5) is pushed out and has entered into the groove (4) of the profile of the basic frame (3), resulting the profile of the sash (1) has been embodied with the basic frame profile (3) and eventually to achieve the circumferential locking of the whole hinged opening frame of a door or a window. FIG. 6 shows the accessory (7) that pushes out or restores the locking profile (5) and it has the lateral projections (8), with the help of which, it enters into the groove (2) of the sash's profile (1). The main accessory (9) of the motion transmission also has lateral projections (8), which help it to “slide” into the groove (2) of the profile of the sash (1), as is shown at FIGS. 4, 5 & 6. FIG. 7 illustrates in detail, the main accessory (9) for the motion transmission from the cremone toward the drive belt (12). Thus, FIG. 7 shows two throughbores (10) and (11) in which screws (commercially available) are entering as follows: the screw in the hole (10) immobilizes one end of the drive belt (12), after having entered the main accessory (9) through the hole of rectangular cross section (14), while the other end of the drive belt, after driven along the perimeter of the frame, it enters to the corresponding rear hole of similar cross-section (15) and finally exits from the upper end of the bore (15).

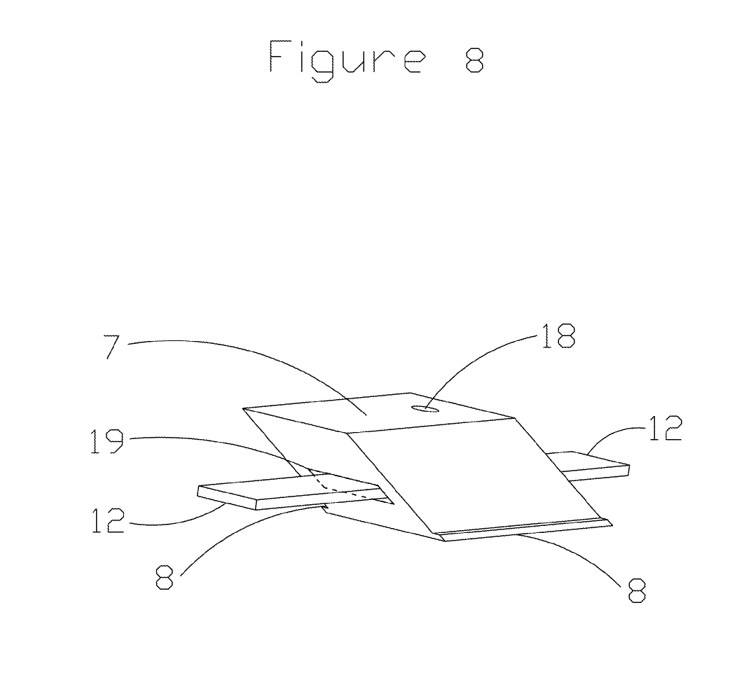

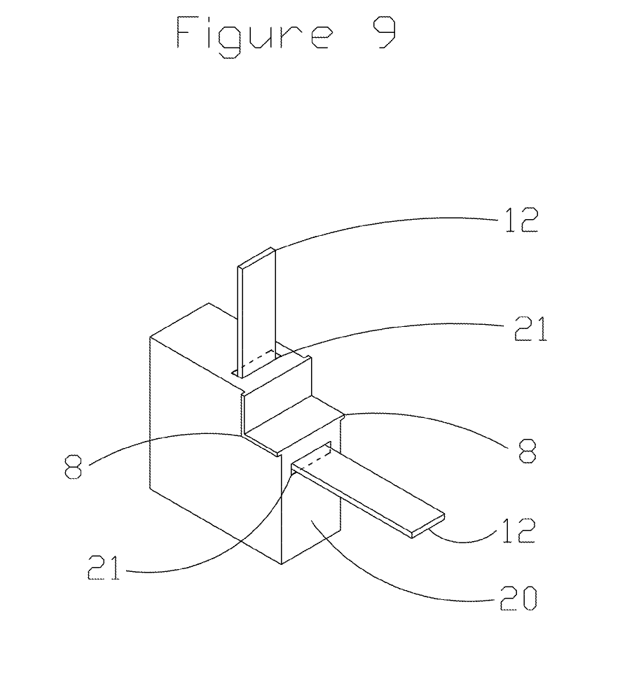

At this stage and before the immobilization of the main accessory (9) to the drive belt (12) with the aid of a screw (commercially available), which goes into the hole (11), precedes a stretching of the drive belt (12) and then the protruding part is to be removed. Also in FIG. 7 is illustrated a pin (17) which goes into the hole (16) of the main accessory (9) and transmits the movement of the cremone, (commercially available), to the main accessory (9). FIG. 8 illustrates in detail the accessory (7), which pushes out or restores the locking profile (5) as is shown in FIG. 6, which has a hole (18) in which a screw (commercially available) goes and immobilizes the accessory (7) on the drive belt (12). Also FIG. 8 illustrates, the throughbore (19) of rectangular cross section, in which the drive belt (12) goes through and also shows, the lateral projections (8), by means of which the accessory (7) “slides” into the groove (2) of the profile of the sash (1). FIG. 9 illustrates the accessory (20) that will be placed at the four corners of the frame, assembled by the sash profile (1), in order to restrict the lateral motion of the locking accessory (5). The accessory (20) also has lateral projections (8) with the aid of which is placed into the groove (2) of the profile of the sash (1) and a throughbore of rectangular cross section (21) from which the drive belt (12) freely passes through, comes out and changes direction.

By the use of the sash's profile (1), the movable opening frame can be assembled and be installed, by means of hinges (commercially available), on the stable framework that has been assembled by the use of the profile of the basic frame (3), according to the well known technical custom.

The basic principle of the implementation of the locking method, according to the invention, can be applied in the following three basic phases.

Phase 1: The main accessory (9) is slid and placed into the groove (2) of the sash's profile (1), which is adjusted to the cremone by the use of the pin (17). As the cremone revolves by an individual, it transforms the rotary motion to linear motion that is moves the main accessory (9), which in turn transfers the motion to the drive belt (12) With whom it is securely attached.

Phase 2: As long as the drive belt (12) moves, it transmits the linear motion to the accessories (7), that push out or restore the locking profiles (5), which are placed. circumferentially along the four sides of the sash's frame (1) and which are securely attached to the drive belt (12).

Phase 3: The accessories (7), which are slid in the groove (2) of the sash's profile (1), because of their slope, as they move towards a direction, oblige the locking profiles (5), to get pushed out along all four sides of the movable frame assembled by the sash's profile (1), since the locking profiles (5) also have in both sides inclined material removal of similar slope. That has as a result the circumferential projection of the locking profiles (5) and their entering into the groove (4) of the profile of the basic frame (3). The reason that the locking profiles (5), are being pushed out from the sash's profile (1) framework, is because of the initial placement of the lateral motion's restriction accessory (20) of the locking profile (5), at the sash's framework's four corners, during the assembling stage of the framework.

At this phase, the movable frame made of the sash profile (1) (glazing or shutter), is locked and embodied with the stable framework made of the basic frame's profile (3), in such a way that it makes the whole hinged opening aluminium frame completely inviolable.

As the cremone revolves afterwards to its original place, the above mechanism is activated backwards and unlocks the movable framework of the sash's profile (1) from the stable framework of the basic frame's profile (3), since the locking profile (5) is forced to return to its original place in the groove (2), at all four sides of the framework. The extremely strong and absolutely secure embodiment of the two frames (movable and stable), of a hinged opening aluminium frame, door or window, in the way that it is described above, is the main principle of the invention.

The above main accessories and materials, can be used in any form desired, in any size or shape and they cooperate, as shown in the drawings attached, according to its main purpose and implementation's method.

For every need concerning construction, the forms of the accessories may be changed, without altering the main principle of the invention, with the advantages that were described above, which are the result of the study and the designing of this invention.

1. (canceled)

2. An inviolable system of hinged frames for opening doors and windows comprising a stable frame of a basic profile member and a movable frame of a sash profile member, said movable frame of the sash profile member hingedly attached onto said stable frame of the basic profile member and being provided with a cremone, said cremone being adapted to rotate with a scope of alternatively setting said hinged frames in a locked condition and an unlocked condition, comprising:
said sash profile member comprising four sides and defining a sash profile groove adapted to receive a locking profile member in each one of the four sides of the movable frame thereof;
said basic profile member having a basic profile groove adapted to host said locking profile member in each one of the four sides of the stable frame thereof when said hinged frames are brought in the locked condition;
said locking profile member being a π-section member that is inserted within said sash profile groove along each one of the four sides of the movable frame of said sash profile member and is provided with means of movement thereof from a position in which said locking profile member is fully inserted within said sash profile groove of said sash profile member to a position in which it is being extended outwardly thereof and vice versa, said means of movement being provided with lateral projections adapted to slide within said sash profile groove of said sash profile member, said means of movement thereby being adapted to push said locking profile member to the locked condition or restore it to the unlocked condition during corresponding rotation of said cremone that sets said hinged frames in the locked condition and the unlocked condition respectively;
an accessory with a through bore being mounted at each one of four corners of the movable frame of said sash profile member, each accessory being adapted to restrict lateral movement of said locking profile member;
said cremone being connected by means of a pin to a main motion transmission accessory that converts rotation of said cremone to linear motion, said main motion transmission accessory being provided with the lateral projections adapted to slide within said sash profile groove of said sash profile member, one end of a drive belt being fixedly mounted within a first hole at a first end of said main motion transmission accessory, said drive belt being driven along a perimeter of the movable frame of said sash profile member, passing freely through the through bore of each one of said accessories at each one of the four corners of the movable frame of said sash profile member and being fixedly connected with said means of movement of said locking profile members, a second end of said drive belt being fixedly mounted within a second hole at a second end of said main motion transmission accessory;
wherein said hinged frames are being set at the locked condition when said locking profile members extend outwardly said sash profile groove of said sash profile member and are being inserted within said basic profile groove of said basic profile member, whereby said sash profile member is being embodied within said basic profile member circumferentially around said hinged frames.

3. The inviolable system of hinged frames for opening doors and windows according to claim 2, wherein said means of movement of said locking profile member is a second accessory having a slope in the direction of movement thereof within said sash profile groove of said sash profile member, said accessory being provided with a second accessory through bore wherein passes said drive belt, said second accessory being securely attached to said drive belt by means of a screw passing through a second accessory hole, each side of said π-section member being provided with inclined cuts wherefrom material has been removed, said inclined cuts having an inclination similar to the slope of said accessory, whereby linear movement of said second accessory within said sash profile groove of said sash profile member initiated by movement of said drive belt results in said locking profile member, as said accessories restrict lateral movement thereof, either being pushed at the locked condition, outwardly said sash profile groove of said sash profile member into said basic profile groove of said basic profile member, or being restored at the unlocked condition, out of said basic profile groove of said basic profile member into said sash profile groove of said sash profile member.
